(19) United States
(12) Patent Application Publication
(10) Pub. No.: US 2009/0092781 A1
(43) Pub. Date: Apr. 9, 2009

(54) Business Forms and Methods of Manufacture

(76) Inventor: Gerald P. Guzi, Roanoke, VA (US)

Correspondence Address: FITCH EVEN TABIN AND FLANNERY, 120 SOUTH LASALLE STREET, SUITE 1600, CHICAGO, IL, 60603-3406, US

(21) Appl. No.: 11/868,238

(22) Filed: Oct. 5, 2007

(51) Int. Cl. B32B 3/16; B32B 38/04

(52) U.S. Cl. 428/42.3; 156/249; 156/267; 156/268

(57) ABSTRACT

Business forms and apparatus and methods for making such forms are disclosed that provide for single-sided printing, such as with common laser or inkjet printers; protected, non-displayed information when attached to a package, such as for packing lists; or unprotected, displayed information when attached to a package, such as for displayed safety information; and/or integrated labels, such as for use with attaching to a package to provide unprotected, displayed information, such as address information.

### FIELD

This disclosure relates generally to business forms for use in shipping and methods of manufacture, and, more particularly, to business forms for use in shipping having one or more adhesive portions and methods of manufacture.

### BACKGROUND

Business forms can be configured for use with shipping packages. In some instances, address information and a packing list are combined into a common form. One example of such as business form is disclosed in U.S. Pat. No. 6,186,554, which has a composite address label and packing list form with a face ply joined to a release liner via adhesive. A border portion of the face ply has adhesive that is covered by a protective border that can be removed to expose the adhesive to permit the form to be adhered to a package. However, printing of address indicia is made on one side of the form and printing of content indicia is printed on an opposite side of the form. This disadvantageously can require either feeding the same form through a common printer, such as a laser printer or inkjet printer, twice (once for printing on each side). Alternatively, a duplex or double sided printer can be used.

Existing business forms configured for same-side printing have other disadvantages. For instance, U.S. Patent Publ. No. 2002/0113428 discloses a combined packing slip and shipping label in the form of a three portion label attached to a release liner. The first part is the shipping label, the second part is a packing slip and the third portion is a connecting tab. The first and second parts are joined via a line of perforations, and the second and third parts are also joined via a line of perforations. The first part of the form is attached to the liner via an adhesive border, the second part of the form is unattached to the liner, and the third part of the form is attached to the liner via adhesive. Thus, the second part of the form is held in place relative to the liner via the first part of the form at one end and via the third part of the form at the other end. Inwardly of the border in the first part of the form are lines of perforation. To use the form, the first and second parts are removed from the liner and the third part of the form is separated from the second part of the form. The first and second parts of the form are then folded together to place the second part of the form adjacent the first part of the form. The second part of the form has a width such that it fits within the adhesive border of the first part of the form, allowing the first part of the form to be attached to a package via the adhesive border. The first and second parts can be removed by separation along the perforations of the first part, thereby leaving the adhesive border attached to the package. However, this form during printing has a substantial portion, the second part, unattached to the liner. During printing, this second part can lift from the liner and cause printer jams and other problems.

Other existing business forms have adhesive only on two sides of the part that affixes to a package. An example of this type of business form is disclosed in U.S. Pat. No. 6,244,629. A drawback of having the business form adhesively attached on only two sides to a package is that there can be a greater propensity for the form to inadvertently be removed from the package. This problem can be exacerbated when tear lines or like are also present in the form, such as in the form disclosed in the '629 patent. Premature tearing along the tear lines can result in a damaged form, and can expose information which otherwise was intended to be kept out of view, such as a packing list.

Accordingly, it has been determined that there exists the need for improved business forms for use in shipping that are more end user friendly, able to better withstand the rigors of shipping and handling when attached to packages, and that facilitate more economical methods of manufacturing.

### SUMMARY

Business forms, and apparatus and methods for making the same, are disclosed herein. The business forms are more end user friendly, are better able to withstand the rigors of shipping and handling when attached to packages and facilitate more economical methods of manufacturing.

In one aspect, certain of the business forms disclosed herein have both an integrated label and a removable segment that can be adhered, for example, to a package or the like. By providing both the integrated label and the removable segment in the same form, the likelihood that the two will inadvertently be used on separate packages or in separate transactions is reduced when they are intended to be used together. This can make the forms more user friendly by reducing the potential for inadvertent mistakes. The integrated label and the removable segment may having printable surfaces on the same side, thereby advantageously permitting the form to be printed in a single pass through a common printer, as opposed to having to feed the form through twice for printing on each side. This also can make the forms more user friendly by making them simpler to print. In another aspect, the business forms do not have significant regions that are unattached to other portions of the form, thereby reducing the propensity of the forms to jam during printing.

In one aspect, a business form is provided that has a base layer with a first liner layer attached to at least a portion of one side and a second liner layer attached to at least a portion of an opposite side. An integrated label is provided in the base layer adjacent the first liner layer. At least a portion of the second liner layer is removable to expose adhesive on an adjacent portion of the base layer. The integrated label can be attached to a package, and at least a portion of the base layer having the exposed adhesive can be attached to the same package. The integrated label and adhesive-backed base layer can also be used in a common transaction, such as by placing the integrated label on a package and the adhesive-backed base layer on a corresponding invoice or the like, or vice versa. The second liner layer may at least partially frame or border an exposed portion of the base layer, whereby printing can be made on both the exposed position of the base layer and the integrated label which can be on the same side of the form. A removable segment may be provided in the exposed portion of the base layer, and any printing thereon may be facing the package, and thus not visible, when attached to a package. A line of weakness may be provided between the portion of the form having the integrated label and the portion with the second liner layer, to permit the integrated label portion to be discarded after removal of the label.

In another aspect, the business forms may be made by adhesively attaching a first liner layer to at least a portion of one side of a base layer and adhesively attaching a second liner layer to at least a portion of an opposite side of the base layer. Die cuts may be made in the base layer adjacent the first liner layer to define a periphery of a removable integrated card. Die cuts may also be made in the second liner layer and an inwardly portion thereof removed to leave a frame or border of a portion of the base layer. The framed portion of the base layer may also have inwardly positioned die cuts to define a removable segment of the base layer.

In another aspect, a business form is provided having a base layer and a liner layer. The liner layer may have a plurality of die cuts defining the periphery of an inner portion of the liner layer, which may be removed to expose a portion of the base layer. The liner layer can be removed to expose adhesive on the base layer to permit the base layer to be adhered to a package, another form, or the like. The exposed portion of the base layer may have a removable segment with its periphery defined by a plurality of die cuts. The form may optionally have extended portion of the base layer with a width sized or adaptable to fit at least partially within the exposed portion of the base layer.

Other aspects of the business forms and methods of manufacture, and equipment therefore, are disclosed herein.

### BRIEF DESCRIPTION OF THE DRAWINGS

FIG. 1 is a perspective view of a shipping label and a packing list from a first embodiment of a business form adhesively attached to a package;

FIG. 2 is a view of the front side of the business form showing the shipping label and packing list of FIG. 1;

FIG. 3 is a view of the back side of the business form of FIG. 2;

FIG. 4 is a section view of the business form of FIG. 2 taken along line 4-4 thereof and showing both the shipping label and the packing list;

FIG. 5A is a section view of the business form of FIG. 2 taken along line 5A-5A thereof and showing the shipping label retained in the business form;

FIG. 5B is a section view of the business form of FIG. 2 similar to that of FIG. 5A, but showing the shipping label with an adhesive backing being removed from the business form;

FIG. 6A is a section view of the business form of FIG. 2 taken along line 6A-6A thereof and showing an adhesive border of the packing list covered by a liner;

FIG. 6B is a section view of the business form of FIG. 2 similar to that of FIG. 6A, but showing the liner being removed from the adhesive border of the packing list;

FIG. 7 is a perspective view of the front side of the business form of FIG. 2 showing the liner covering the adhesive border of the packing list and the shipping label being removed from the business form;

FIG. 8 is a perspective view of the front side of the business form of FIG. 2 showing a top portion of the business form with the shipping label removed being separated from a bottom portion of the business form with the liner being removed from the adhesive border of the packing list;

FIG. 9 is a perspective view of the front side of a second embodiment of a business form having a shipping label, shown as being removed, and a packing list with a discontinuous liner covering a segmented adhesive border of the packing list;

FIG. 10 is a perspective view of the front side of the business form of FIG. 9 showing a top portion of the business form with the shipping label removed being separated from a bottom portion of the business form with the discontinuous liner being removed from the segmented adhesive border of the packing list;

FIG. 11 is a perspective view of the front side of a third embodiment of a business form having a pair of removable labels in a bottom portion of the form being removed and a packing list in a top portion of the form;

FIG. 12 is a perspective view of the front side of the business form of FIG. 11 with the top and bottom portions being separated and a liner covering an adhesive border of the packing list being removed;

FIG. 13 is a perspective view of the front side of a fourth embodiment of a business form having a packing list surrounded by an adhesive border covered by a liner and an integral shipping label showing the shipping label being removed;

FIG. 14 is a perspective view of the front side of the business form of FIG. 13 showing the liner being removed from the adhesive border of the packing list;

FIG. 15A is a section view of the business form of FIGS. 13 and 14 showing the shipping label retained in the business form and the liner covering the adhesive border of the packing list;

FIG. 15B is a section view of the business form of FIGS. 13 and 14 similar to that of FIG. 15A, but showing the shipping label being removed from the business form;

FIG. 15C is a section view of the business form of FIGS. 13 and 14 similar to that of FIGS. 15A and 15B, but showing the liner being removed from covering the adhesive border of the packing list;

FIG. 16 is a perspective view of a front side of a fifth embodiment of a business form having a top portion and a bottom portion, with the top portion having a shipping label being removed and the bottom portion a packing list;

FIG. 17 is a perspective view of a back side of the business form of FIG. 16 showing a liner being removed from covering an adhesive border of the back of the packing list;

FIG. 18A is a section view of the business form of FIG. 16 taken along line 18-18 thereof and showing the shipping label retained in the business form and the liner covering the adhesive border of the back of the packing list;

FIG. 18B is a section view of the business form of FIG. 16 similar to that of FIG. 18A, but showing the top and bottom portions being separated, the shipping label being removed from the top portion and the liner being removed from the adhesive border of the packing list;

FIG. 19 is a view of the front side of a sixth embodiment of a business form having a packing list with a segmented adhesive border covered by a discontinuous liner with the liner being removed;

FIG. 20A is a section view of the business form of FIG. 19 taken along line 20-20 thereof and showing the liner covering the adhesive border of the packing list;

FIG. 20B is a section view of the business form of FIG. 19 similar to that of FIG. 20A but showing the liner being removed from covering the adhesive border of the packing list;

FIG. 21 is a perspective view of a front side of a seventh embodiment of a business form having a packing list with a liner covering an adhesive border;

FIG. 22 is a perspective view of a back side of the business form of FIG. 21;

FIG. 23A is a section view of the business form of FIG. 21 taken along line 23-23 thereof showing the liner covering the adhesive border of the packing list;

FIG. 23B is a section view of the business form of FIG. 21 similar to that of FIG. 23A, but showing the liner being removed from the adhesive border of the packing list;

FIG. 24 is a perspective view of the front side of the business form of FIG. 21 with side edges of a lower portion being removed;

FIG. 25 is a perspective view of the front side of the business form of FIG. 21 with the side edges of the lower portion removed and the liner removed from the adhesive border of the packing list in an upper portion of the business form, with the lower portion being folded toward the upper portion;_and

FIG. 26 is a diagrammatic representation of a method and apparatus for manufacturing business forms.

### DETAILED DESCRIPTION OF THE DRAWINGS

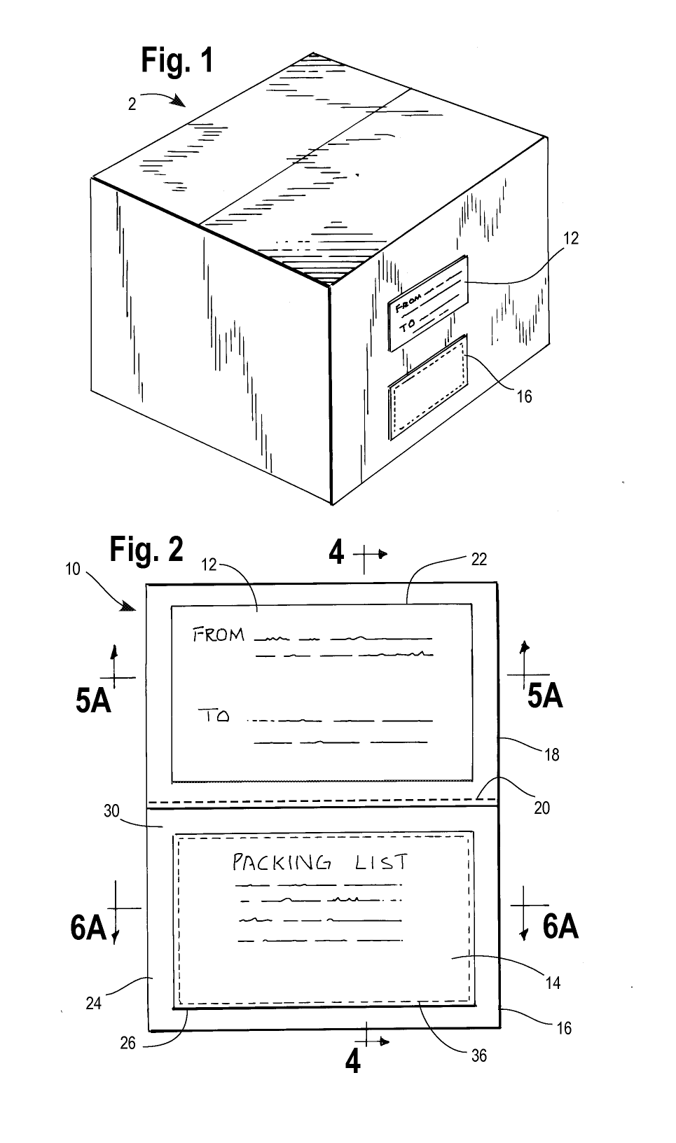

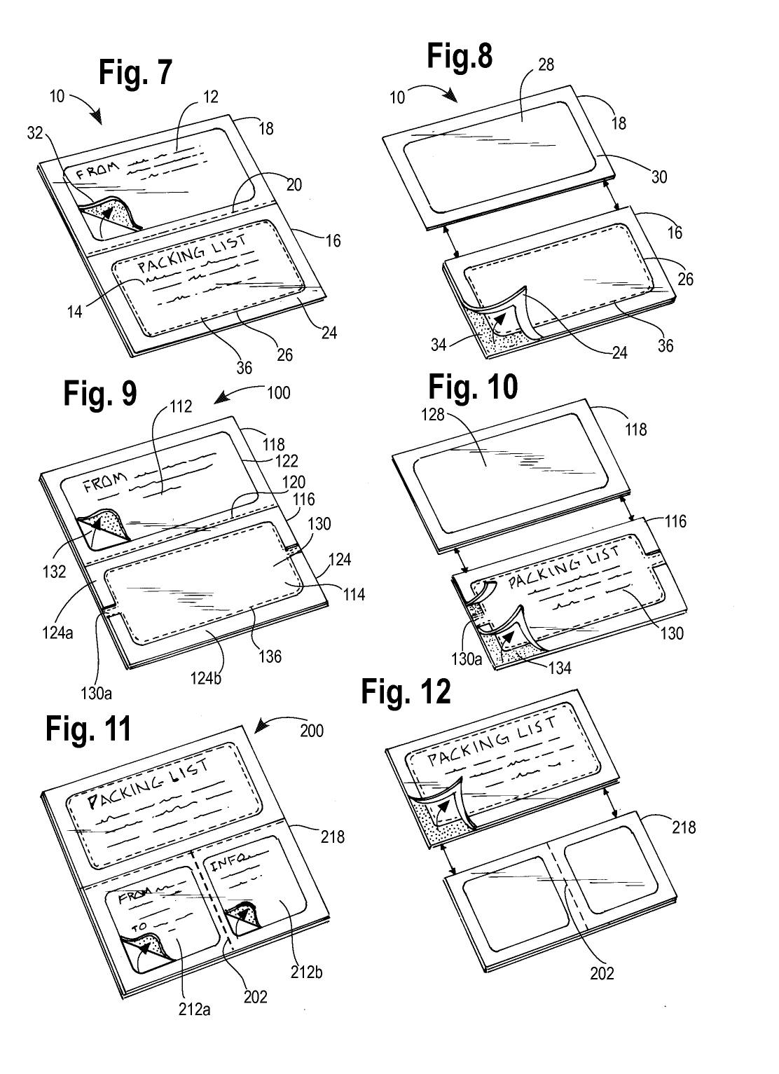

Business forms and apparatus and methods for making such forms are described herein and depicted in FIGS. 1-26. The forms advantageously provide for single-sided printing, such as with common laser or inkjet printers; protected, non-displayed information when attached to a package, such as for packing lists; and/or integrated labels, such as for use with attaching to a package to provide unprotected, displayed information, such as address information. In certain of the forms, the non-displayed information is on a common form with the displayed information to reduce the likelihood of this information inadvertently becoming separate when intended for use on the same package or transaction.

The business form 10 of the first embodiment, depicted in FIGS. 2-8, has a base layer 30 with a first part 18 and a second part 16 joined via an optional line of weakness 20. As will be explained in greater detail, the first part 18 of the form 10 has an integrated removable label 12 and the second part 16 of the form 10 has a removable segment 14. The base layer 30 has a printable first side and an opposite, second side which also may be printable. The line of weakness, as that term is used herein, can be a score line, a thinned die line, a perforation or the like that permits separation of the first part 18 from the second part 16 of the form 10, while restricting unintentional separation. The configuration of the label 12 and the removable segment 14 advantageously permits printing to be made on both the label 12 and the segment 14, and specifically on the first side of the base layer 30, such as in a single pass through a common printer, such as a laser printer or an inkjet printer. Providing both the label 12 and the removable segment 14 in the same business form 10 advantageously reduces the likelihood that the two items could be separated from each other and inadvertently attached to different packages if they are intended to be attached to the same package.

In one example of a use of the business form 10, address information can be printed on the integrated label 12 and a packing list can be printed on the removable segment 14. The integrated label 12 can be removed from the form and adhesively attached to a package 2, as illustrated in FIG. 1, and the first part 18 of the form discarded. The second part 16 of the form, having the removable segment 14, can be adhesively attached to the same package 2, as will be described in greater detail herein. Providing both the packing list and the address information on the same form can reduce the likelihood that the two will be inadvertently attached to different packages, while also permitting same-side printing of the form 10.

Turning to more details of the construction of the business form 10, a first liner layer 28 is attached via adhesive 32 to the second side of the base layer 30 in the first part 18 thereof, and a second liner layer 24 is attached via adhesive 34 to the first side of the base layer 30 in the second part 16 thereof. A plurality of die cuts 22 extend through the first part 18 of the base layer 30 to define a periphery of the removable integrated label 12 that is coextensive with the base layer 30, as depicted in FIGS. 2, 4 and 5A. The first liner layer 28 has a lesser affinity for the adhesive 32 as compared to the second side of the base layer 30, such that when the label 12 is removed from the form it has an adhesive backing, as illustrated in FIG. 5B, that permits the label 12 to be adhered to a package 2, as.

A second liner layer 24 is attached via adhesive 34 to the first side of the second part 16 of the base layer 30, as depicted in FIGS. 4 and 6A. The second liner layer 24 has a central opening 26 such that it frames the removable segment 14 of the second part 16 of the form 10, as illustrated in FIGS. 2, 4 and 7. This permits printing to be made on the exposed portion of the base layer 30 within the central opening 26 of the second liner layer 24. The exposed portion of the base layer 30 may not have adhesive applied to facilitate printing thereon. The second liner layer 24 has a lesser affinity for the adhesive 34 as compared to the first side of the base layer 30, such that when the second liner layer 24 is removed, as illustrated in FIGS. 6B and 8, the adhesive 34 is exposed permitting the second part 16 of the form 10 to be adhered to a package 2.

Alternatively, instead of having the central opening 26 of the second liner layer 24, a plurality of die cuts may be made to form a perimeter portion surrounding an inner portion of the second liner layer 24. Both the inner portion and the perimeter portion may be adhesively attached to the first side of the base layer 30. However, the inner portion of the second liner layer 24 can be left on the form, and may have an outwardly-facing printable side. To attach this alternative second portion of the form to a package, the perimeter portion of the second liner layer 24 may be removed to expose the underlying adhesive, leaving the inner portion, and the second portion attached to the package via the exposed adhesive.

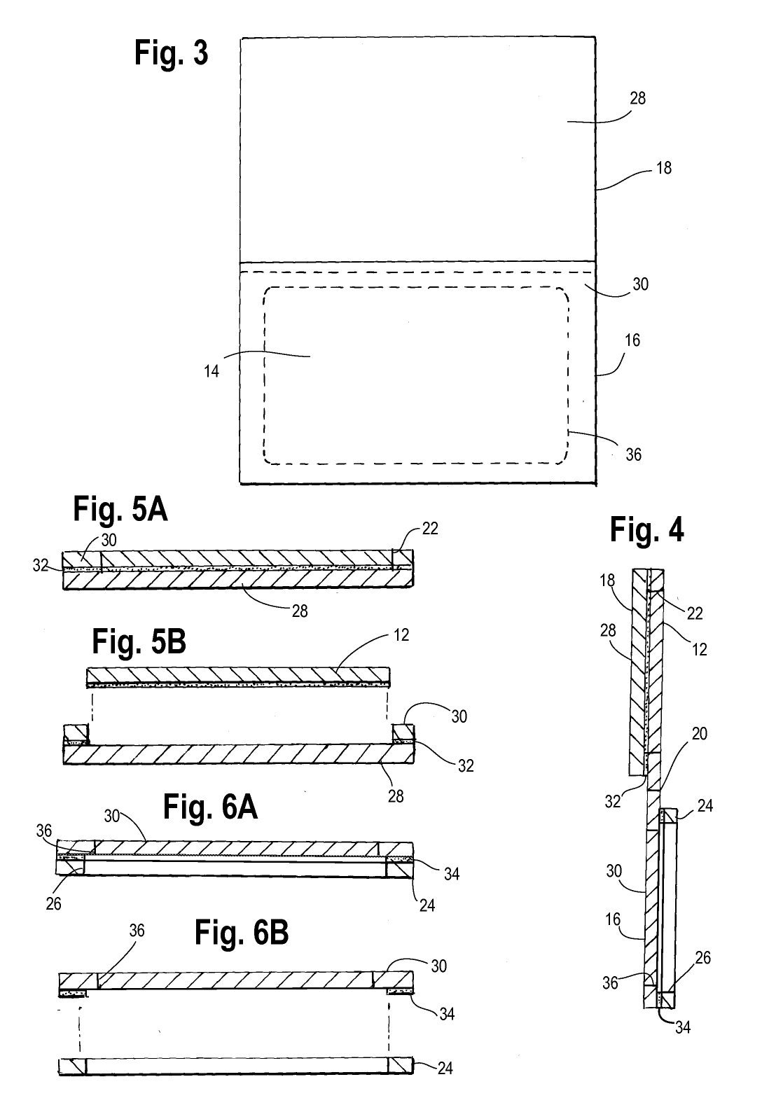

The removable segment 14 of the second part 16 of the form 10 has a periphery defined by a plurality of die cuts 36 extending at least partially through the base layer 30, as illustrated in FIGS. 2 and 3. The plurality of die cuts or perforations 36 and gaps therebetween form a perforated periphery of the segment 14. The perforated periphery allows for the segment 14 to readily be removable from the business form 10, while also maintaining the segment 14 in the business form 10 and protecting against unintentional removal. To this end, the perforations 36 are spaced apart a sufficient distance from adjacent perforations 36 in order to have a plurality of bridging portions disposed therebetween to assist in maintaining the segment 14 in the form 10 against unintentional removal from the form 10. Although die cuts or perforations 36 are described and depicted, other suitable lines of weakness can be utilized. The die cuts 36 are inwardly spaced and within the central opening 26 of the second liner layer 28. To remove the removable segment 14 from the second part 16 of the business form 10, such as when the second part 16 is adhesively attached to a package 2, the removable segment 14 can be separated from the remainder of the second part 16 of the form along the die cuts 36. Removal of the segment 14 can then permit viewing of any printed information on the first side of the base layer 30, which previously was facing the package 2 and thus not visible. A cut-out extending through the base layer 30 may be positioned adjacent the die cuts 36 defining the perimeter of the segment 14 in order to facilitate removal of the segment 14 from the second part 16 of the form 10.

In a second embodiment, depicted in FIGS. 9 and 10, the business form 100 has a construction similar to that of the form 10 of the first embodiment of FIGS. 1-8. The form 100 has a first part 118 with an integrated removable label 112 defined by a plurality of die cuts 122 extending substantially through a base layer 130 to an underlying first liner layer 128 attached via adhesive 132. The form 100 also has a second part 116 with a second liner layer 124 about a perimeter adhesive pattern 134, with a removable segment 114 having a border defined by a plurality of die cuts extending at least partially through the base layer 130. An optional line of weakness 120 separates the two parts 116 and 118 of the form 100. However, the business form 100 of the second embodiment differs from that of the first embodiment in that the second liner layer 124 is formed of two discontinuous segments 124a and 124b, as illustrated in FIGS. 9 and 10. The discontinuous segments 124a and 124b are separated by a pair of gaps through with a small portion 130a of the base layer 130 is exposed. These small portions 130a of the base layer 130 are free from adhesive 134, and can function to facilitate removal of the segment 114 from the second part 116 of the form 100 when the form 100 is attached to a package. In addition, the small portions 130a can interconnect the inner portions of the second liner layer 124 to adjacent inner portions of adjacent forms 100 during manufacture, as will be discussed in greater detail below. Although two small portions 130a are illustrated, one small portion or more than two small portions can also be formed.

A third embodiment of a business form 200, illustrated in FIGS. 11 and 12, is similar in construction to the form 10 discussed above with reference to FIGS. 1-8. However, instead of having a single integrated removable label 12, a pair of integrated removable labels 212a and 212b are formed in the first part 218 of the form 200. An optional line of weakness 202 may optionally be provided to permit the first part 218 of the form 200 to be separated so that each integrated label 212a and 212b can be on a then-separated carrier. Although two labels are illustrated, any number of labels can be formed. Moreover, although the two labels 212a and 212b are illustrated as being spaced from each other, they may be adjacent or contiguous, sharing a common edge.

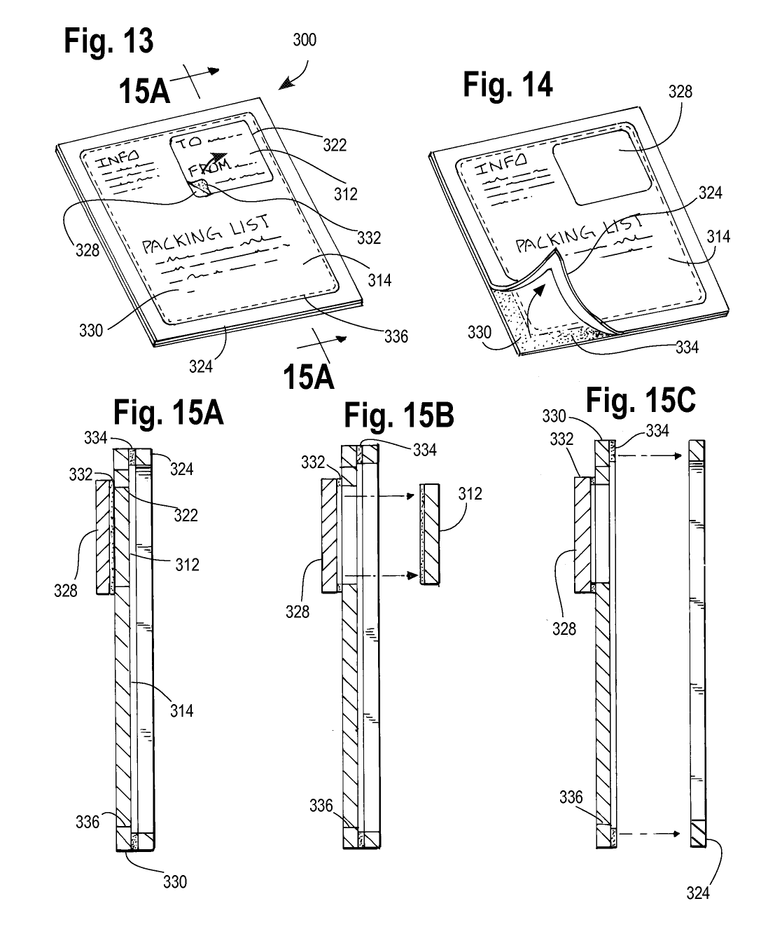

Moreover, with the addition of a liner layer on the second side of the base layer and adjacent the second part of the form, an integrated label can also be provided in the removable segment if desired in any of the aforementioned forms 10, 100 and 200. Alternatively, the business form 300 may have one part, instead of two parts, with an integrated label 312 within the removable segment 314, as illustrated in FIGS. 13-15. The business form 300 of FIGS. 13-15 has a base layer 330 with a perimeter second liner layer 324 covering a perimeter adhesive pattern 334 on a first side of the base layer 330. The second liner layer 324 frames or borders the removable segment 314, defined by a plurality of die cuts 336, and is removable to expose the underlying adhesive 334 to permit adhesive of the form 300 to a package, for example. However, the segment 314 also has a first liner layer 328 attached via adhesive to the second side of the base layer 330 may be coextensive, though not necessarily coextensive, with the removable segment 314. The integrated label 312, defined by a plurality of die cuts 322, is removable from the form 300, such as for adhesion to a package or the like.

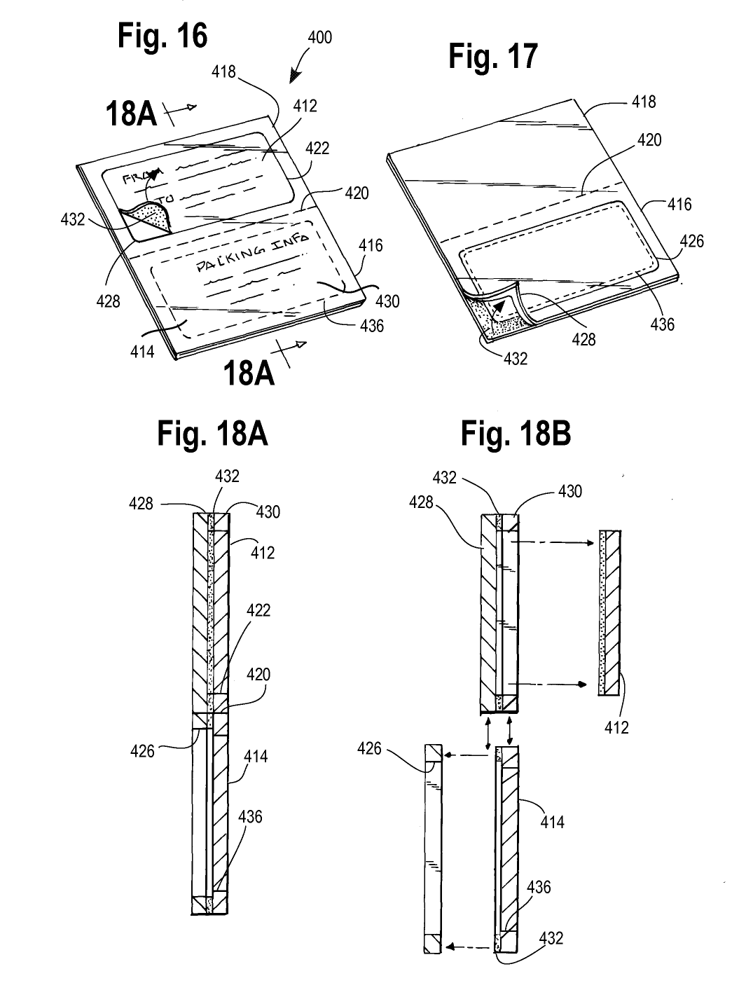

In a fifth embodiment, illustrated in FIGS. 16-18, a business form 400 is provided with a removable integrated label 412 on a front side of a first part 418 of the form 400, and a second part 416 of the form 400 having adhesive 432 on the back side. Printing on the front side of the form 400 thus may result in printing on the label 412, as well as printing on the adhesive-backed second part 416 of the form 400. With printing on the front side of the adhesive-backed second part 416, the printing will not be hidden from view as in the previous embodiments. However, in some instances it may be desirable not to have the printing hidden from view, such as when printing contains indicia that should be readily known about package contents. An example would be safety information or information about hazardous contents, fragile contents, or the like. Such information may be desirable to have visible on the outside of a package. The form 400 advantageously permits removal of a segment 414 of the second part 416 of the form 400 should it be desired to have the information printed thereon separate from the package, such as if it is to be kept with contents removed from the package. Printing may also or instead be made on the back side of the second part 416 of the form 400.

Turning to details of the construction of the form 400 of the fifth embodiment, the business form 400 has a base layer 430 with a liner layer 428 attached to a second side thereof via the adhesive 432. As discussed above, the removable integrated label 412 is provided in the first part 418 of the form, and its periphery is defined by a plurality of die cuts 422. The liner layer 428 adjacent a second part 416 of the form 400 has a central opening 426 through which the second side of the base layer 430 is exposed for printing. As in certain of the previous embodiments, the first and second parts 418 and 416 may be separable from each other along an optional line of weakness 420. Also, the second part 416 contains a plurality of die cuts 436 which define the perimeter of the removable segment 414 of the form 400.

To use the form 400, the label 412 may be removed from the first part 418, as illustrated in FIGS. 16 and 18B. The second part 416 of the form 400, having the removable segment 414, can be separated from the first part 418 of the form 400 along the line of weakness 420, if present. The liner layer 428, in the form of a border or frame of the removable segment 414, can be removed to expose the adhesive 432 backing the second part 416. The label 412 can be attached to a package, for example, to display address information or the like. The second part 416 of the form 400, having printing on its front face, can be adhered, for example, to the same package as the label 412 to display the printing on the front face thereof. The removable segment 414 may be removed from the package along the perforations 436 to remove the printed information from the package, such as after shipment. Having the label 412 and the segment 414 in the same form 400 advantageously reduces the likelihood that they will be inadvertently be separated when they are intended for use on the same package or in the same transaction.

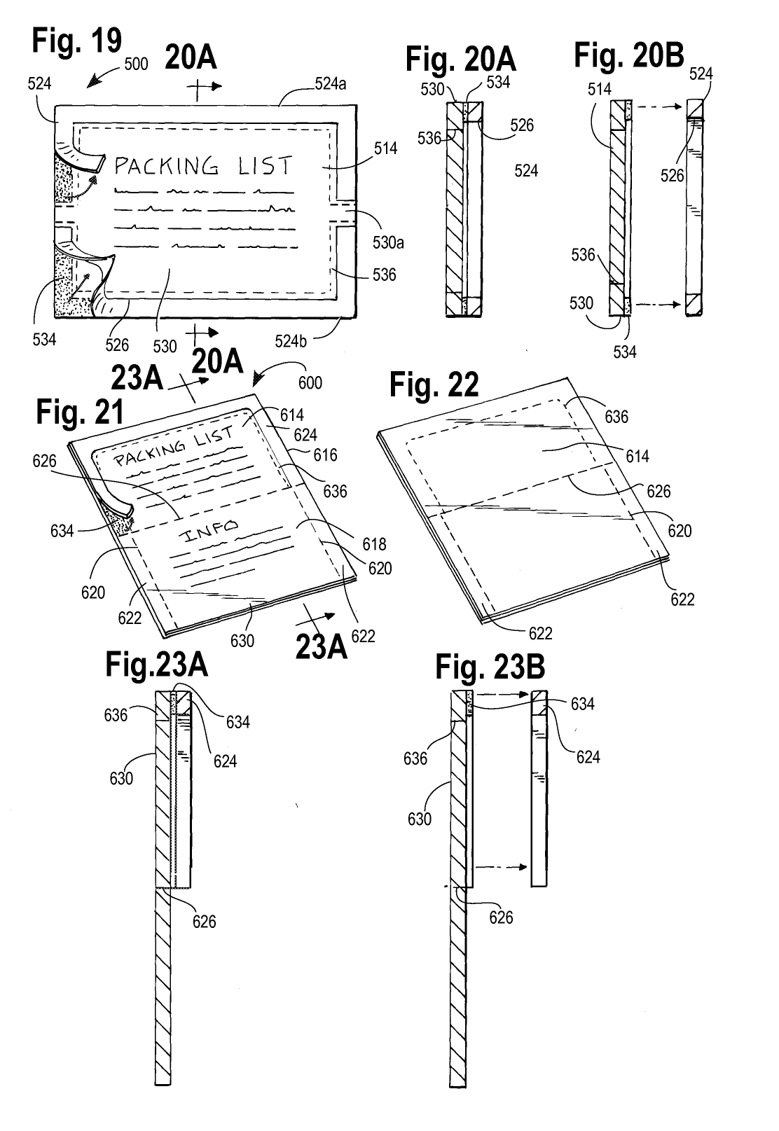

In a sixth embodiment of a business form 500, illustrated in FIGS. 19 and 20, a removable segment 514 is provided in the form 500 and has its perimeter defined by a plurality of die cuts 536 extending at least partially through a base layer 530. The base layer 530 has a liner layer 524 attached via an adhesive perimeter pattern 534. The liner layer 524 has a central opening 526 through which the base layer 530 and the segment 514 thereof are exposed, such as for printing. The liner layer 524 can be removed to expose the underlying adhesive pattern 534 to permit the form 500 to be adhered to a package, for example. The liner layer 524 has two different segments 524a and 524b spaced by small portions 530a of the base layer 530, for purposes described above with respect to the business form 100 of the second embodiment.

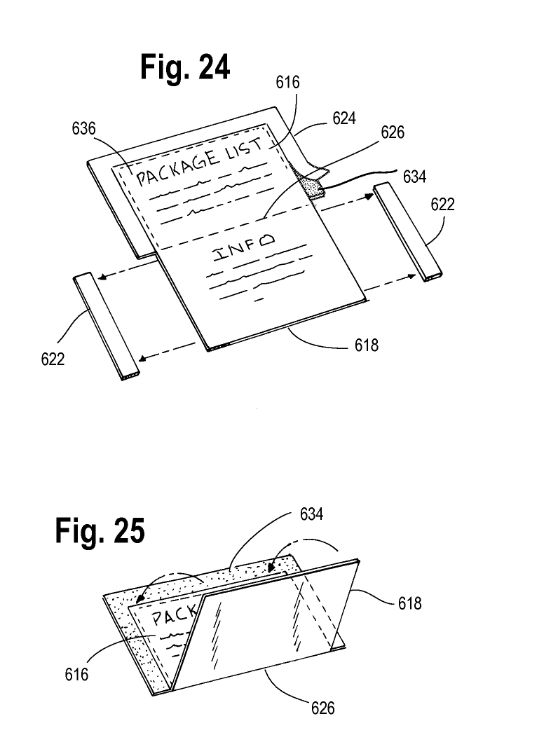

Finally, a seventh embodiment of a business form 600 is illustrated in FIGS. 21-25. The business form 600 has a base layer 630 with a first part 616 and a second part 618. The first part has a peripheral liner layer 624 on three sides, but not on the side adjacent a fold line 626 connecting the second part 618. Side edge portions 622 of the second part 618 of the form are separable via lines of weakness 620 to permit removal from the form 600 and to reduce the width of the second part 618 of the form 600, as illustrated in FIG. 24. The second part 618 of the form 600 can then be folded along the fold line 626 to bring it adjacent to the first part of the form 600, as illustrated in FIG. 25. The folded form 600 can then be attached to a package or the like using the exposed adhesive 634 once the liner layer 624 has been removed. A removable segment of the form 600, comprising a portion 614 of the first part 616 of the form with a perimeter defined on three sides via a plurality of die cuts 636 and the second part 618 attached via the fold line 626, can be separated from the form 600 after attachment to a package, such as to view the printed material thereon.

Any of the aforementioned forms may optionally incorporated Radio Frequency Identification (“RFID”) tags or transponders, whether active or passive. For example, the aforementioned integrated labels may include RFID tags to make them “smart labels.” The RFID tags may be placed, for example, between the base layer and the liner layer of the part of the form having the integrated label such that the RFID tag is attached to the label when the label is removed from the form. Alternatively or in addition, the RFID tags may be adhered to the removable segments, if the RFID tag is to remain with the removable segment, or the parts of the forms having the removable segments, if the RFID tag is to remain with that part of the form after removable of the removable segments. Other “smart tag” technologies or the like can be substituted or used in addition to the RFID tag on the forms disclosed herein.

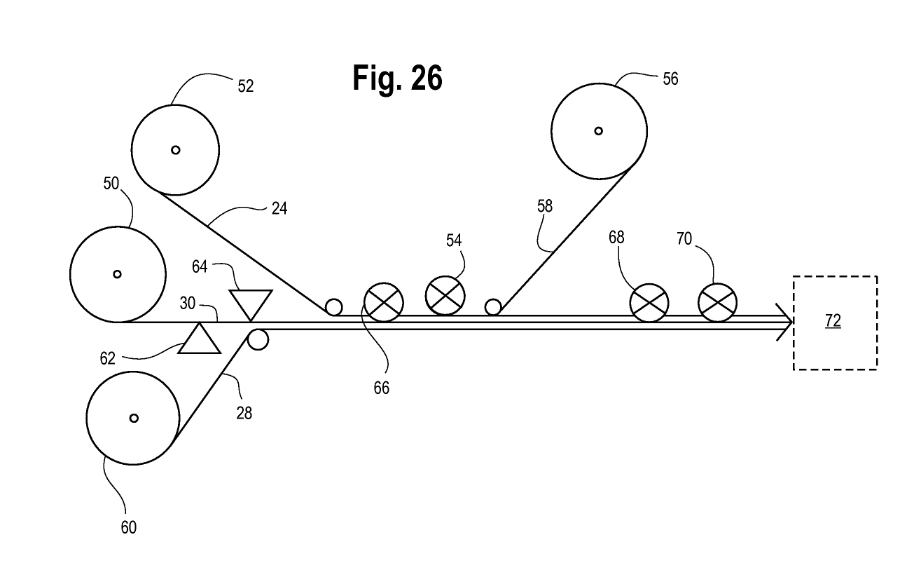

Turning now to the methods and apparatus for manufacturing the business form 10 of the first embodiment, an example of which is illustrated in FIG. 26, unwind stations are provided for unwinding rolls 50, 52 and 60 of the base layer 30, the second liner layer 24, and the first liner layer 28, respectively. The adhesive 32 is applied to either the second side of the base layer 30 or the first liner layer 28 at an adhesive station 62. Similarly, the adhesive 34 is applied to either the first side of the base layer 30 or the second liner layer 24 at another adhesive station 64. The adhesive 34 can either be applied in a pattern, such as a perimeter pattern, the entirety of the second liner layer 24, or other portions thereof. After the first liner layer 28 has been adhesively attached to the base layer 30, the die cuts 22 are made using a die cut station 66 in the base layer 30 to define the periphery of the integrated removable card 12. After the second liner layer 24 has been adhesively attached to the base layer 30, the die cuts defining the central opening 26 are made using another die cut station 54 in the second liner layer 24 to permit removal of portion within the central opening 26. If the form is of the type of the second embodiment, illustrated in FIGS. 9 and 10 discussed above, the removed portions within the central opening 126 are interconnected via the connecting portions 130a, permitting the removed portions 58 to be continuous from one form to the next and wound up on a discard roll 56. Another die cut station 68 can be used to form the die cuts 36 of the perimeter of the removable segment 14, and yet another die cut station 70 can be used to form the line of weakness 20 between the first and second parts 18 and 16 of the form 10. After manufacture of the forms 10, the forms 10 may be provided in variety of output configurations using finishing equipment 72, such as by winding into a roll, fan-folding, sheeting or the like. Although certain orders of manufacture are depicted in FIG. 26 and described herein, other orders of manufacture and assembly steps may also be suitable. For example, some of the die cut stations may be combined, such as stations 68 and 70. Furthermore, although the liner layers 24 and 28 are depicted and described as being continuous from one form to the next, one or both may be applied in patches using suitable equipment, such as vacuum rollers.

By way of examples of the types of materials that may be used in the manufacture of the forms described herein, with reference to the form of the first embodiment but applicable to all embodiments, the liner layers 24 and 28 may be made of material and treated such that it has reduced binding characteristics to allow for the label 12 or the second liner layer 28 to be easily separated for use by the end user but that will not become detached during printing. Suitable examples of liner material includes silicone coated glassine on both sides, as well as Teflon® coated glassine and bleachcraft may be substituted for glassine. The liner layers 24 and 28 may be formed of a transparent film to permit for any printing or other indicia on the adjacent side of the base layer 30 to be visible through the liner layers 24 and 28. The liner layers 24 and 28 may also be printable. The base layer 30 may be formed of a cardstock material or a lower weight material suitable for printing and feeding through printers. The adhesives 32 and 34 may be hot melt adhesive or any other adhesive capable of releasably attaching the liner layers 24 and 28 to the base layer 30.

The drawings and the foregoing descriptions are not intended to represent the only embodiments of the business forms in regard to the details of construction and methods of manufacture. Changes in form and in the proportion of parts, as well as the substitution of equivalents, are contemplated as circumstances may suggest or render expedient; and although specific terms have been employed, they are intended in a generic and descriptive sense only and not for the purposes of limitation.

1. A business form having a removable label and an adhesively-attachable portion, the business form comprising:
a base layer having a printable first side and an opposing second side;
a first liner layer adhesively secured to the second side of the base layer, the first liner layer having a lesser affinity for retaining adhesive than an adjacent portion of the base layer;
an integrated removable label comprising at least a portion of the base layer adjacent the first liner layer, the label having a periphery edge substantially defined by a plurality of die cuts extending substantially through the base layer; and
a second liner layer adhesively secured to the first side of the base layer, the second liner layer having a lesser affinity for retaining adhesive than an adjacent portion of the base layer, at least a portion of the second liner layer being removable from the base layer to expose the adhesive.

2. The business form of claim 1, wherein the second liner layer has a printable side opposite the side adhesively secured to the first side of the base layer.

3. The business form of claim 1, wherein the second liner layer has an opening permitting access to the first side of the base layer.

4. The business form of claim 1, wherein the second liner layer substantially frames a portion of the first side of the base layer, which portion is free from adhesive.

5. The business form of claim 4, wherein the second liner layer extends continuously around the portion of the first side of the base layer that is free from adhesive.

6. The business form of claim 4, wherein the second liner layer has a plurality of separate, spaced segments.

7. The business form of claim 4, wherein the portion of the first side of the base layer framed by the second liner layer has a plurality of die cuts positioned inwardly from the second liner layer and extending at least partially through the base layer to substantially define a removable segment of the portion of the base layer.

8. The business form of claim 7, wherein a plurality of bridging portions are disposed between adjacent die cuts to connect the removable segment of the portion of the base layer and the base layer so that the bridging portions maintain the removable segment in the form against unintentional removal from the form.

9. The business form of claim 7, wherein a line of weakness is formed in the base layer to permit separation of a label portion of the form having the integrated label from the portion of the form having the removable segment, the first liner layer and the second liner layer each being spaced from the line of weakness.

10. The business form of claim 7, wherein a second integrated removable label is provided, the second integrated removable label comprising at least a portion of the base layer, the second label having a periphery edge substantially defined by a plurality of die cuts extending substantially through the base layer.

11. The business form of claim 10, wherein:
a line of weakness is formed in the base layer to permit separation of a label portion of the form having the integrated labels from the portion of the form having the removable segment, the first liner layer and the second liner layer each being spaced from the line of weakness; and
the second integrated removable label is spaced from the integrated removable label and a line of weakness is formed in the base layer to permit separation of the portion of the form having the integrated removable label from a portion of the form having the second integrated removable label.

12. A multi-part business form having a first part with a removable label and a second adhesively-attachable part, the business form comprising:
a base layer having a printable first side and an opposing second side, the base layer having a first part and a second part;
a first liner layer adhesively secured to the second side of first part of the base layer, the first liner layer having a lesser affinity for retaining adhesive than an adjacent portion of the base layer;
an integrated removable label comprising at least a portion of the first part of the base layer, the label having a periphery edge substantially defined by a plurality of die cuts extending substantially through the base layer;
a second liner layer adhesively secured to at least a portion of a perimeter portion of the first side of the second part of the base layer, the second liner layer having a lesser affinity for retaining adhesive than an adjacent portion of the base layer, at least a portion of the second liner layer being removable from the second part of the base layer to expose the adhesive, and the second liner layer; and
an exposed, removable segment of the second part of the base layer framed by the second liner layer, the removable segment having a periphery edge substantially defined by a plurality of die cuts extending at least partially through the base layer.

13. The business form of claim 12, wherein a plurality of bridging portions are disposed between adjacent die cuts to connect the removable segment of the portion of the base layer and the base layer so that the bridging portions maintain the removable segment in the form against unintentional removal from the form.

14. The business form of claim 12, wherein a line of weakness separates the first part of the form from the second part of the form, and the first and second liner layers are each spaced from the line of weakness.

15. The business form of claim 12, wherein the second liner layer surrounds the removable segment.

16. The business form of claim 15, wherein the second liner layer has a plurality of spaced segments.

17. The business form of claim 15, wherein the second liner layer is continuous about the perimeter portion of the second part of the base layer.

18. A method of producing a business form having a removable integrated label and a removable segment, the method comprising:
adhesively attaching a first liner layer to a back side of a base layer, the first liner layer having a lesser affinity for retaining adhesive than an adjacent portion of the base layer;
adhesively attaching a second liner layer to a front side of the base layer opposite the back side, the second liner layer having a lesser affinity for retaining adhesive than an adjacent portion of the base layer;
forming a plurality of die cuts extending substantially through the base layer adjacent the first liner layer to define a periphery edge of an integrated removable label comprising at least a portion of the base layer;
forming a plurality of die cuts extending at least partially through the base layer adjacent the second liner layer to define at least a portion of a periphery edge of a removable segment of the base layer; and
forming a plurality of die cuts extending substantially through the second liner layer to divide the second liner layer into a removable portion spaced outwardly from the periphery edge of the removable segment of the base layer and an inwardly remainder portion.

19. The method of claim 18, further comprising the step of removing the remainder portion of the second liner layer.

20. The method of claim 18, further comprising the step of forming a line of weakness in the base layer to divide the form into a first part having the integrated removable label and a second part having the removable segment.

21. The method of claim 21, wherein:
the step of adhesively attaching the first liner layer to the back side of the base layer includes positioning the first liner layer on one side of the line of weakness adjacent the integrated removable label; and
the step of adhesively attaching the second liner layer to the front side of the base layer includes positioning the first liner layer on one side of the line of weakness adjacent the removable segment.

22. A method of using a label and a removable segment of a business form with a package, the method comprising:
providing a business form having an integrated removable label in a first part of the form and a removable segment in a second part of the form, the integrated removable label and the removable segment having a common base layer;
printing on a first side of the base layer coextensive with the integrated removable label;
printing on the first side of the base layer coextensive with the removable segment;
removing the label from the form and adhesively attaching the label to a package; and
removing a liner at least partially surrounding the removable segment to expose adhesive and adhesively attaching the second part of the form having the removable segment to the package.

23. The method of claim 22, further comprising the step of removing the removable segment from the second part of the form after the second part of the form has been adhesively attached to the package.

24. The method of claim 23, further comprising the step of separating the first and second parts of the form from each other along a line of weakness therebetween prior to adhesively attaching the second part of the form to the package.

25. A business form for attachment to a package, the business form comprising:
a base layer having a printable first side and a second, opposite side;
a liner layer adhesively attached to the first side of the base layer on a pair of side edge portions and a top edge portion of a first portion of the base layer and unattached to a bottom edge portion of the first portion of the base layer, the liner layer having a lesser affinity for adhesive than the top and side edge portions of the first side of the base layer;
a second portion of the base layer adjacent the bottom edge portion of the first portion of the base layer, the second portion having side edge portions removable from the business form to leave a remainder portion, the remainder portion having a width the same as or less than the width between the side edge portions of the first portion of the base layer having the liner layer adhesively attached thereto, the remainder portion being foldable to bring the remainder adjacent to the first portion of the base layer; and
a removable segment of the business form comprising the second portion of the base layer and an inward portion of the first portion of the base layer inwardly from the top and side edges of the base layer having adhesive thereon and defined by a plurality of die cuts extending at least partially through the base layer and inwardly from the top and side edges of the base layer having adhesive thereon.
